(19) United States
(12) Patent Application Publication
(10) Pub. No.: US 2011/0189369 A1
(43) Pub. Date: Aug. 4, 2011

(54) BAKED CONFECTIONERY

(75) Inventor: Yuki ISHIDA, Tokyo (JP)

(73) Assignee: Kao Corporation, Chuo-ku (JP)

(21) Appl. No.: 13/014,158

(22) Filed: Jan. 26, 2011

(30) Foreign Application Priority Data
Jan. 29, 2010 (JP) 2010-18075

(51) Int. Cl. A23G 3/36; A21D 13/08

(52) U.S. Cl. 426/549

(57) ABSTRACT

The present invention provides baked confectionery, including (A) wheat flour, (B) a gelatinized modified starch, and (C) oils and fats and satisfying the conditions of (1), (2), and (3):
(1) a weight ratio of (A) to (B), (A)/(B), is 90/10 to 60/40,
(2) the content of (C) is 30 to 75 parts by weight to 100 parts by weight of (A) and (B) in total,
(3) the proportion of liquid oils and fats (having a melting point not higher than 20° C.) in (C) is 30 to 90% by weight.

### FIELD OF THE INVENTION

The present invention relates to baked confectionery containing grain flour as a main component.

### REFERENCE TO RELATED APPLICATION

This application is based upon and claims the benefit of the priority of Japanese patent application No. 2010-018075, filed on Jan. 29, 2010, the disclosure of which is incorporated herein in its entirety by reference thereto.

### BACKGROUND OF THE INVENTION

Bakery products based mainly on wheat flour generally contain solid fats such as shortening and margarine in order to soften bodies and improve feel to eat, dissolving feel in the mouth and tastes thereof. The same is true on baked confectionery (in Japan, many of them are referred to as cookies and biscuits). These have been conventionally required to have a lighter and more shortcrust texture. Among them, those categorized as a soft cookie are particularly popular. A soft cookie gets a light and shortcrust texture by increasing proportions of solid fats and sugars, but also has disadvantages of clumping in the mouth and having a sticky and powdery feel in the mouth to eat.

To solve these problems, there is a method of replacing a part of a solid fat used in producing baked confectionery to liquid oils and fats (see, JP-A 2006-166909).

However, an increased amount of oils and fats generally causes problems in production of lowered processability in cutting and oil-exuding and disadvantages of oily taste and feel to eat.

There are also known methods, including that of replacing not a solid fat but a part of wheat flour, which is a main component, to a modified starch to produce baked confectionery having shortcrust texture and a good dissolving feel in the mouth (see, JP-A 10-99011) and that of using a gelatinized starch to provide a formed snack having shortcrust texture and good dissolving feel in the mouth (see, JP-A 11-146762).

JP-A 2003-250431 discloses a baked food containing a dietary fiber and oils and fats.

JP-A 2010-104236, corresponding to US Patent Application 2010/0104707 filed on 29 Apr. 2010, discloses baked confectionery containing an esterified starch or an etherified starch.

JP-A 2010-142127, corresponding to US Patent Application 2010/0151105 filed on 17 Jun. 2010, discloses a flour composition for confectionary product containing wheat flour, a gelatinized starch, and a wheat protein.

### SUMMARY OF THE INVENTION

The present invention provides baked confectionery, containing (A) wheat flour, (B) a gelatinized modified starch, and (C) oils-and-fats and satisfying the conditions of (1), (2), and (3):

(1) a weight ratio of (A) to (B), (A)/(B), is 90/10 to 60/40,

(2) the content of (C) is 30 to 75 parts by weight to 100 parts by weight of (A) and (B) in total,

(3) the proportion of liquid oils and fats (having a melting point not higher than 20° C.) in (C) is 30 to 90% by weight.

The present invention further provides baked confectionery containing (A) wheat flour, (B) a gelatinized modified starch, and (C) oils and fats containing 30% or more by weight of diacylglycerol and satisfying the conditions of (1), (2), and (3). The present invention further provides baked confectionery, comprising (A) wheat flour, (B) a gelatinized modified starch, and (C) oils and fats comprising 30% or more of diacylglycerol and satisfying the conditions of (1), (2), and (3):

(1) a weight ratio of (A) to (B), (A)/(B), is 90/10 to 60/40,

(2) the content of (C) is 30 to 75 parts by weight to 100 parts by weight of (A) and (B) in total,

(3) the proportion of liquid oils and fats (having a melting point not higher than 20° C.) comprising the diacylglycerol in an amount of not less than 30% by weight in (C) is 30 to 90% by weight.

The present invention also provides a method for producing baked confectionery, containing blending (A) wheat flour, (B) a gelatinized modified starch, and (C) oils and fats so as to satisfy the conditions of (1), (2) and (3) to prepare a dough, and baking the dough.

### DETAILED DESCRIPTION OF THE INVENTION

The inventors of the present invention have tried to use liquid oils and fats for improving feel to eat in production of baked confectionery which has dissolving feel in the mouth, and unexpectedly found that use of the liquid oils and fats has effects not only on feel to eat as conventionally known but also on taste and provides a rich but non-fatty taste. According to the finding, the present inventors have used the liquid oils and fats in a larger amount than that disclosed in JP-A 2006-166909, but encountered problems in production, such as a lowered processability in mold releasabiity and oil-exuding.

The present inventors also have studied for modified starches used as different improvers of feel-to-eat, and found that use of a gelatinized modified starch in an specific amount unexpectedly suppresses oil-exuding to improve physical properties of a dough and provides good taste. The present invention thus has been accomplished.

According to the present invention, use of liquid oils and fats and a specific modified starch in dough preparation suppresses oil-exuding from the dough and improves processability of the dough, and provides baked confectionery having a good taste.

The baked confectionery of the present invention contains the wheat flour (A) and the gelatinized modified starch (B). A weight ratio of the wheat flour to the gelatinized modified starch, wheat flour/gelatinized modified starch, is preferably 90/10 to 60/40, more preferably 87/13 to 65/35, and even more preferably 85/15 to 70/30. Within the range of 90/10 to 60/40, baked confectionery has a good feel to eat and a good taste, being not oily in eating due to suppression of oil-exuding. Oil-exuding is also suppressed in production of baked confectionery. The range is advantageous in handling such as molding.

Examples of the wheat flour (A) used in the present invention include weak flour, moderate wheat flour, semi-hard wheat flour and hard wheat flour. From the points of shortcrust texture and dissolving feel in the mouth, weak flour is preferably used. The baked confectionery of the present invention may also contain a grain flour other than the wheat flour and the gelatinized modified starch (hereinafter, referred to as the other grain flour). Examples of the other flour include modified starches that are not gelatinized, rice flour, and soybean flour. In this case, the wheat flour preferably accounts for not less than 80% of the total flours of the wheat and the other grain flours for feel to eat, taste, and suppression of oil-exuding in production. 100% of wheat flour is more preferable.

For the gelatinized modified starch (B) used in the present invention, from the viewpoint of suppression of oil-exuding in eating and in production, a gelatinized esterified starch or a gelatinized etherified starch is preferably used.

Examples of esterification include acetylation, modification with octenyl succinate, and modification with phosphate monoester. Among these esterifications, acetylation is preferred. A modified starch can be produced by reacting a starch with acetic anhydride, octenyl succinate, or a phosphate salt to modify the starch. Examples of the phosphate salt include sodium ortho-phosphate and sodium tripolyphosphate. Examples of the etherification include hydroxypropylation.

These esterified and etherified starches are preferably further subjected to a cross-linking treatment.

Examples of the cross-linking treatment include phosphate cross-linking and adipate cross-linking. Preferred are acetylated adipate-crosslinked starch, acetylated phosphate-crosslinked starch, hydroxypropylated phosphate-crosslinked starch, phosphate monoester-modified phosphate-crosslinked starch, because these can be produced from starch with a simple process at relatively low cost with high purity.

Gelatinization (or pregelatinization) refers to a phenomenon in which a starch is heat-treated in the presence of water to cause loss of crystallinity of starch particles, resulting in the starch swelling or dissolving. A degree of gelatinization can be measured by a standard β-amylase/pullulanase method (Michinori Nakamura and Keiji Kainuma eds. “Biochemical Experimental Methods, 19, Experimental Methods on Starch and Related Saccharides”, Japan Scientific Societies Press (1986)). In the present invention, a modified starch having a high degree of gelatinization is preferably used in order to suppress oil-exuding. More specifically, a degree of gelatinization is preferably not less than 20%, more preferably 30 to 100%, and even more preferably 40 to 99%.

In one aspect of the present invention, for the gelatinized modified starch, a degree of substitution of acetyl group in an acetylated adipate-crosslinked starch and an acetylated phosphate-crosslinked starch is preferably higher than 0.04, more preferably 0.05 to 0.1, and even more preferably 0.06 to 0.09 from the viewpoint of physiology. A degree of substitution of hydroxypropyl group in a hydroxypropylated phosphate-crosslinked starch is preferably higher than 0.1, more preferably 0.1 to 0.5, and even more preferably 0.1 to 0.3 from the viewpoint of physiology. A degree of adipate-crosslinking in an acetylated adipate-crosslinked starch is preferably 0.005 to 0.135% by weight (hereinafter, simply referred to as %), more preferably 0.01 to 0.08%, and even more preferably 0.015 to 0.05%. A degree of phosphate-crosslinking in an acetylated phosphate-crosslinked starch and a hydroxypropylated phosphate-crosslinked starch is preferably 0.005 to 0.14%, more preferably 0.01 to 0.08%, and even more preferably 0.015 to 0.05%.

Examples of the raw material for the modified starch include waxy corn starch, corn starch, wheat starch, rice starch, glutinous rice starch, potato starch, sweet potato starch, and tapioca starch. From the viewpoints of feel to eat and production cost, preferred are waxy corn starch and tapioca starch.

The baked confectionery of the present invention contains the oils and fats (C). From the viewpoints of feel to eat, taste, and suppression of oil-exuding, the total amount of the oils and fats is 30 to 75 parts by weight (hereinafter, simply referred to “parts”), preferably 35 to 70 parts, more preferably 40 to 65 parts, and even more preferably 40 to 60 parts to 100 parts by weight of the wheat flour (A) and the gelatinized modified starch (B) in total.

The oils and fats used in the present invention may be of animal or vegetable. Examples of the oils and fats include plastic ones, such as butter, lard, margarine, and shortening, liquid oils and fats and hydrogenated oils (solid fats) prepared therefrom, and interesterified oils. Various oils and fats can be used.

In the present invention, for the oils and fats, oils and fats having a melting point of 25 to 50° C. and liquid oils and fats having a melting point of 20° C. or lower are used in combination. From the viewpoint of feel to eat, taste such as rich body and light after taste, and suppression of oil-exuding, a content of the liquid oils and fats having a melting point of 20° C. or lower is preferably 30 to 90%, more preferably 40 to 80%, and even more preferably 50 to 75% of the total oils and fats. In this case, a content of unsaturated fatty acids is preferably 50 to 90%, more preferably 60 to 86%, and even more preferably 70 to 82% of the total fatty acids constructing the oils and fats. Further, the total content of linoleic and linolenic acids is preferably 15 to 55%, more preferably 20 to 50%, even more preferably 25 to 45%, and still even more preferably 30 to 43% of the total fatty acids constructing the oils and fats.

For the oils and fats described above, animal and vegetable oils and hydrogenated oils (solid fats) prepared therefrom, and interesterified oils are used.

Specific examples of the oils and fats include animal oils such as beef tallow, lard, and fish oil and vegetable oils such as soy oil, palm oil, palm kernel oil, cottonseed oil, peanut oil, canola oil, corn oil, safflower oil, sunflower oil, and rice oil.

The “liquid oils and fats” collectively refers oils and fats having a melting point of 20° C. or lower and being in the state of liquid. Specific examples of the liquid oils and fats include vegetable oils such as corn oil, olive oil, cottonseed oil, canola oil, soybean oil, palm oil, sesame oil, sunflower oil, safflower oil and cooking oil.

In one aspect of the present invention, from the viewpoint of taste (light after taste) and dissolving feel in the mouth, the liquid oils and fats preferably contains diacylglycerol in an amount of not less than 30%, more preferably 40 to 100%, and even more preferably 50 to 90%.

In one aspect of the present invention, from the viewpoints of good dissolving feel in the mouth, improved moist feel to eat, physiological effects, and industrial productivity of oils and fats, a content of unsaturated fatty acids in fatty acids composing the diacylglycerol is preferably not less than 90%, more preferably 93 to 100%, even more preferably 93 to 98%, and still even more preferably 94 to 98%. From the viewpoint of physiological effects, the number of carbon atoms in the unsaturated fatty acids is preferably 14 to 24, and more preferably 16 to 22.

From the viewpoints of taste, physiological effects, and stability against oxidizing, a content of oleic acid in fatty acids composing the diacylglycerol is preferably 20 to 65%, more preferably 25 to 60%, even more preferably 30 to 50%, and still even more preferably 30 to 45%. From the same viewpoints, a content of olein-olein diacylglycerol is preferably less than 45%, and more preferably 0 to 40%.

From the viewpoints of taste, physiological effects, and stability against oxidizing, a content of linoleic acid in fatty acids composing the diacylglycerol is preferably 15 to 65%, more preferably 20 to 60%, even more preferably 30 to 55%, and still even more preferably 35 to 50%. Further, from the viewpoints of stability against oxidizing, compatibility, retention of shape, and physiological effects, a content weight ratio of linoleic acid/oleic acid is preferably 0.01 to 2, more preferably 0.1 to 1.8, and even more preferably 0.3 to 1.7. Considering effects particularly on health, the content weight ratio of linoleic acid/oleic acid is preferably not more than 2, and from the viewpoints of intake of essential fatty acids, not less than 0.01.

From the viewpoints of taste, stability against oxidizing, and physiological effects, a content of linoleic acid in fatty acids composing the diacylglycerol is preferably less than 15%, more preferably 0 to 13%, even more preferably 1 to 10%, and still even more preferably 2 to 9%. There are known two isomers of linolenic acid: α-linolenic acid and y-linolenic acid. From the points of physiological effects, preferred is α-linolenic acid.

From the viewpoints of taste, stability against oxidizing, dissolving in the mouth, physiological effects, and industrial productivity of oils and fats, a content of saturated fatty acids in fatty acids composing the diacylglycerol is preferably 0 to 10%, more preferably 0 to 7%, even more preferably 2 to 7%, and still even more preferably 2 to 6%. Among saturated fatty acids, preferred are those having 14 to 24 carbon atoms, and more preferred are 16 to 22. Palmitic acid and stearic acid are especially preferred.

The baked confectionery according to the present invention is preferably selected from the group consisting of cookies, biscuits, shortbreads and crackers. A composition of the baked confectionery is preferably such that the total content of the oils and fats and sugars is more than 40 parts to 100 parts of the wheat flour and the gelatinized in total. Considering this composition, preferred are cookies, biscuits, and shortbreads.

From the viewpoints of taste and feel to eat, the baked confectionery of the present invention has a degree of gelatinization of the total starches in the prepared baked confectionery after production is preferably not less than 12%, more preferably 15 to 60%, and even more preferably 20 to 40%.

In one aspect of the present invention, methods of producing baked confectionery include rotary, cutting-embossing, wire-cutting, route-press, and depositing.

Raw materials for the baked confectionery of the present invention may include sub materials, as well as the wheat flour, the gelatinized modified starch, and the oils and fats as main materials. Sub materials are appropriately selected according to need, including grain flours other than “the wheat flour and the gelatinized modified starch”, sugars, egg, water, dairy products, common salt, yeast, seasonings (e.g., sodium glutamates and nucleic acids), preservatives, reinforcing agents such as vitamins and calcium, proteins, amino acids, chemical expanding agents, and flavors. Dry fruits such as raisin, wheat bran, and chocolates can further be appropriately used.

In one aspect of the present invention, any sugar generally used in baked confectionery can be used. Specific examples of the sugar used in the present invention include monosaccharides such as glucose, fructose, and galactose, polysaccharides such as maltose, sucrose, malt sugar, starch syrup, isomerized sugar, invert sugar, cyclodextrin, branched cyclodextrin, and dextrin, reduced sugars such as starch hydrolysates, and sweeteners such as sorbitol, maltitol, xylitol, sucralose, aspartame, and acesulfame potassium. These may be used alone or in combination. An amount of sugars used is preferably 5 to 90 parts, more preferably 10 to 70 parts, and even more preferably 15 to 55 pats to 100 parts of the wheat flour and the gelatinized modified starch in total.

In recent years, softer feel to eat for biscuits, cookies, and shortbreads has been required. Under this circumstance, the baked confectionery produced preferably has a moisture content of 5 to 15%, and more preferably 6 to 12%. Considering storage stability, a water activity of the baked confectionery produced is preferably 0.4 to 0.8 and more preferably 0.5 to 0.7.

### EXAMPLES

The following Examples demonstrate the present invention. Examples are intended to illustrate the present invention and not to limit the present invention.

### [Wheat Flour]

A weak flour (Nisshin Flour Milling Inc., Violet) was used.

### [Starch]

Starches used in Examples and Comparative Examples, and degrees of gelatinization, substitution [(DS: degree of substitution): the number of substituents per glucose residue], and cross-linking [(%): % by weight of adipic acid or phosphorus per gram of starch] of them are shown in Table 1. A degree of gelatinization was measured according to a method described in the above-mentioned Document. Degrees of substitution and gelatinization were measured by standard methods.

TABLE 1

| | | | | | | | Degree of |
|---|---|---|---|---|---|---|---|
| | | | | | Degree of | Degree of | cross- |
| | Trade name | | | | gelatini- | substiotution | linking |
| | of starch | Supplier | Kind of modification | Gelatinization | zation | (DS) | (%) |
| (a) | Ultra- | National Starch | Acetylated adipate- | Gelatinization | 62.0% | 1.9 | 0.04 |
| | Tex 2 | Food Innovation | crosslinked | | | | |
| (b) | Instant | National Starch | Acetylated adipate- | Gelatinization | 61.9% | 1.9 | 0.04 |
| | Clear gel | Food Innovation | crosslinked | | | | |
| (c) | Ultra- | National Starch | Hydroxypropylated | Gelatinization | Not less | 5.6 | 0.02 |
| | Tex 4 | Food Innovation | phosphate-crosslinked | | than 99% | | |
| (d) | Colflo 67 | National Starch | Acetylated adipate- | — | 5.3% | 2.2 | 0.03 |
| | | Food Innovation | crosslinked | | | | |
| (e) | Thermflo | National Starch | Hydroxypropylated | — | 6.0% | 5.2 | 0.02 |
| | | Food Innovation | phosphate-crosslinked | | | | |
| (f) | Waxy α D-6 | Nihon Shokuhin | Unmodified | Gelatinization | Not less | 0 | 0 |
| | | Kako Co., Ltd. | | | than 99% | | |
| (g) | Amioca | National Starch | Unmodified | — | 4.2% | 0 | 0 |
| | | Food Innovation | | | | | |

[Oils and Fats]

Solid fat (margarine); Cherry Gold E (Kao Corporation, oils and fats: 82.2%, drop melting point of oils and fats: 40.0° C., unsaturated fatty acids in oils and fats: 56.4%, linoleic acid: 11.7%, linolenic acid: 2.0%)

Liquid oils and fats 1 (DAG-rich oils and fats); Kenkou Econa cooking oil (Kao Corporation, TAG content: 10.8%, DAG content: 88.4%, MAG content: 0.8%, unsaturated fatty acid: 90.1%, linoleic acid: 47.7%, linolenic acid: 7.3%)

Liquid oils and fats 2 (TAG-rich oils and fats); soybean oil (Nisshin Oillio Group, Ltd., TAG content: 97.9%, DAG content: 2.1%, unsaturated fatty acid: 80.4%, linoleic acid: 50.8%, linolenic acid: 6.8%)

As used herein, TAG refers “triacylglycerol”, DAG “diacylglycerol”, and MAG “monoacylglycerol”.

### Examples 1 to 10 and Comparative Examples 1 to 11

Starches in Table 1 and oils and fats listed above in amounts as shown in Table 2 and other raw materials in amounts as shown below were used to prepare shortbreads of Examples and Comparative Examples.

TABLE 2
Composition of grain flours and oils-and-fats

| | | | Example | | | | | | | | | | Comparative example | | |
|---|---|---|---|---|---|---|---|---|---|---|---|---|---|---|---|
| | | | 1 | 2 | 3 | 4 | 5 | 6 | 7 | 8 | 9 | 10 | 1 | 2 | 3 |
| Com- | Grain | Wheat | 90 | 60 | 80 | 80 | 80 | 80 | 80 | 80 | 80 | 80 | 100 | 40 | 80 |
| po- | flour | flour | | | | | | | | | | | | | |
| si- | (part) | (a) | 10 | 40 | 20 | 20 | 20 | 20 | 20 | — | — | 20 | — | 60 | 20 |
| tion | | (b) | — | — | — | — | — | — | — | 20 | — | — | — | — | — |
| | | (c) | — | — | — | — | — | — | — | — | 20 | — | — | — | — |
| | | (d) | — | — | — | — | — | — | — | — | — | — | — | — | — |
| | | (e) | — | — | — | — | — | — | — | — | — | — | — | — | — |
| | | (f) | — | — | — | — | — | — | — | — | — | — | — | — | — |
| | | (g) | — | — | — | — | — | — | — | — | — | — | — | — | — |
| | | Total | 100 | 100 | 100 | 100 | 100 | 100 | 100 | 100 | 100 | 100 | 100 | 100 | 100 |
| | Oils- | Margarine | 20 | 20 | 15 | 25 | 40 | 20 | 10 | 20 | 20 | 20 | 20 | 20 | 5 |
| | and- | Liquid oils- | 40 | 40 | 30 | 50 | 20 | 40 | 50 | 40 | 40 | — | 40 | 40 | 10 |
| | fats | and-fats 1 | | | | | | | | | | | | | |
| | (parts) | Liquid oils- | — | — | — | — | — | — | — | — | — | 40 | — | — | — |
| | | and-fats 2 | | | | | | | | | | | | | |
| | | Total | 56 | 56 | 42 | 71 | 53 | 56 | 58 | 56 | 56 | 56 | 56 | 56 | 14 |
| | | Content | 71 | 71 | 71 | 71 | 38 | 71 | 86 | 71 | 71 | 71 | 71 | 71 | 71 |
| | | of liquid | | | | | | | | | | | | | |
| | | oils-and- | | | | | | | | | | | | | |
| | | fats in | | | | | | | | | | | | | |
| | | oils-and- | | | | | | | | | | | | | |
| | | fats (%) | | | | | | | | | | | | | |
| | | DAG | 88.4 | 88.4 | 88.4 | 88.4 | 88.4 | 88.4 | 88.4 | 88.4 | 88.4 | 2.1 | 88.4 | 88.4 | 88.4 |
| | | content | | | | | | | | | | | | | |
| | | in liquid | | | | | | | | | | | | | |
| | | oils-and- | | | | | | | | | | | | | |
| | | fats (%) | | | | | | | | | | | | | |
| E- | Proc- | Sup- | 4 | 4 | 5 | 3 | 4 | 5 | 3 | 5 | 5 | 5 | 1 | 1 | — |
| val- | ess- | pres- | | | | | | | | | | | | | |
| u- | ability | sion | | | | | | | | | | | | | |
| a- | | of oil | | | | | | | | | | | | | |
| tion | | exuding | | | | | | | | | | | | | |
| | | Lightness | 4 | 4 | 3 | 3 | 4 | 4 | 4 | 4 | 4 | 4 | 3 | 2 | — |
| | | of dough | | | | | | | | | | | | | |
| | | Integra- | 5 | 4 | 3 | 4 | 5 | 5 | 5 | 5 | 5 | 5 | 2 | 1 | — |
| | | tion | | | | | | | | | | | | | |
| | | of dough | | | | | | | | | | | | | |
| | | Firmness | 4 | 5 | 4 | 3 | 3 | 5 | 4 | 5 | 5 | 5 | 3 | 1 | — |
| | | of dough | | | | | | | | | | | | | |
| | Taste/ | Richness | 5 | 5 | 4 | 5 | 3 | 5 | 5 | 5 | 5 | 5 | 3 | 1 | — |
| | tex- | Plainness | 4 | 4 | 4 | 3 | 4 | 5 | 5 | 5 | 5 | 4 | 3 | 1 | — |
| | ture | Dissolving | 5 | 4 | 4 | 5 | 4 | 5 | 5 | 5 | 5 | 4 | 2 | 1 | — |
| | | feel in the | | | | | | | | | | | | | |
| | | mouth | | | | | | | | | | | | | |

| | | | Comparative example | | | | | | | |
|---|---|---|---|---|---|---|---|---|---|---|
| | | | 4 | 5 | 6 | 7 | 8 | 9 | 10 | 11 |
| Com- | Grain | Wheat | 80 | 80 | 80 | 80 | 80 | 80 | 80 | 100 |
| po- | flour | flour | | | | | | | | |
| si- | (part) | (a) | 20 | 20 | 20 | — | — | — | — | — |
| tion | | (b) | — | — | — | — | — | — | — | — |
| | | (c) | — | — | — | — | — | — | — | — |
| | | (d) | — | — | — | 20 | — | — | — | — |
| | | (e) | — | — | — | — | 20 | — | — | — |
| | | (f) | — | — | — | — | — | 20 | — | — |
| | | (g) | — | — | — | — | — | — | 20 | — |
| | | Total | 100 | 100 | 100 | 100 | 100 | 100 | 100 | 100 |
| | Oils- | Margarine | 50 | 55 | 5 | 20 | 20 | 20 | 20 | 60 |
| | and- | Liquid oils- | 40 | 5 | 55 | 40 | 40 | 40 | 40 | — |
| | fats | and-fats 1 | | | | | | | | |
| | (parts) | Liquid oils- | — | — | — | — | — | — | — | — |
| | | and-fats 2 | | | | | | | | |
| | | Total | 81 | 50 | 59 | 56 | 56 | 56 | 56 | 49 |
| | | Content | 49 | 10 | 93 | 71 | 71 | 71 | 71 | — |
| | | of liquid | | | | | | | | |
| | | oils-and- | | | | | | | | |
| | | fats in | | | | | | | | |
| | | oils-and- | | | | | | | | |
| | | fats (%) | | | | | | | | |
| | | DAG | 88.4 | 88.4 | 88.4 | 88.4 | 88.4 | 88.4 | 88.4 | — |
| | | content | | | | | | | | |
| | | in liquid | | | | | | | | |
| | | oils-and- | | | | | | | | |
| | | fats (%) | | | | | | | | |
| E- | Proc- | Sup- | 1 | 5 | — | 1 | 1 | 1 | 1 | 5 |
| val- | ess- | pres- | | | | | | | | |
| u- | ability | sion | | | | | | | | |
| a- | | of oil | | | | | | | | |
| tion | | exuding | | | | | | | | |
| | | Lightness | 3 | 3 | — | 2 | 2 | 2 | 2 | 3 |
| | | of dough | | | | | | | | |
| | | Integra- | 1 | 3 | — | 1 | 1 | 1 | 1 | 3 |
| | | tion | | | | | | | | |
| | | of dough | | | | | | | | |
| | | Firmness | 1 | 4 | — | 4 | 4 | 4 | 4 | 3 |
| | | of dough | | | | | | | | |
| | Taste/ | Richness | 2 | 3 | — | 3 | 3 | 3 | 3 | 3 |
| | tex- | Plainness | 2 | 3 | — | 4 | 4 | 4 | 4 | 3 |
| | ture | Dissolving | 1 | 3 | — | 3 | 3 | 3 | 3 | 1 |
| | | feel in the | | | | | | | | |
| | | mouth | | | | | | | | |

### <Composition of Ingredients>

### Ingredient x:

margarine (in an amount shown in Table 2)

liquid oils and fats 1 (in an amount shown in Table 2)

liquid oils and fats 2 (in an amount shown in Table 2)

superfine sugar 40 parts

skim milk powder 5 parts

common salt 1 part

### Ingredient y:

whole egg 20 parts

### Ingredient z:

wheat flour (in an amount shown in Table 2)

starch (in an amount shown in Table 2)

### [Preparation Method of Shortbread]

1) Ingredient x (margarine, liquid oils and fats, superfine sugar, skim milk powder, common salt) was weighed and stirred in a mixer for 30 seconds at a low speed. A dough was prepared by stirring it for 3 minutes at a medium speed to have a specific gravity of 0.70, including stopping the mixer and scraping dough attached to the wall. A specific gravity of the dough was measured in a specific gravity cup according to the following calculation formula.

Specific gravity (g/mL)=Dough weight (g)/Volume of specific gravity cup (mL)

2) To the dough prepared in 1) was added beaten whole egg (ingredient y) as three aliquots over 90 seconds with stirring at low speed. After adding each aliquot of beaten whole egg, the dough was stirred for 30 seconds. Before adding the third aliquot, oils attached to the wall of the mixer was scraped off. The dough was finally stirred for 1 minute at a middle speed to give a uniform creamy dough.

3) To the dough prepared in 2) was added ingredient z, which was previously mixed to a uniform state, and stirred for 45 seconds at a low speed to prepare a dough.

4) 20 g of the dough prepared in 3) was filled in a rectangular baking pan having dimensions of 72 mm long by 22 mm wide by 14 mm tall, and placed on a baking sheet lined with parchment paper. Six holes were created by pricking the surface of the dough with a toothpick. Twelve pans thus prepared were arranged in three lines each consisting of four pans per baking sheet.

5) The baking sheet was placed on three stacked baking sheets and covered with aluminum foil.

6) Baking was conduced in an oven at 160° C. for 20 minutes with aluminum foil covering and for 20 minutes without aluminum foil covering.

7) The baked product was cooled for 20 minutes at a room temperature on a net, placed in a polyethylene zipper bag, and stored in a temperature-controlled room at 20° C. for 1 day to give a shortbread sample.

### [Evaluation Method of Oil-Exuding]

The shortbread dough prepared in 3) was filled in the pan in the amount as described in 4). Six holes were created by pricking the surface of the dough with a toothpick. The pan was allowed to stand on filter paper for 5 minutes. An amount of oils moving (exuding) to the filter paper was measured and ranked according to the following scale for evaluation of oil-exuding.

5: less than 0.01 g/20 g of dough

4: 0.01 g to 0.02 g/20 g of dough

3: 0.02 g to 0.03 g/20 g of dough

2: 0.03 g to 0.04 g/20 g of dough

1: more than 0.04 g/20 g of dough

Shortbread samples of Examples and Comparative Examples were subjected to sensory evaluations for processability (“lightness of dough”, “integration of dough” and “firmness of dough”), taste (“richness” and “plainness”) and feel to eat (“dissolving feel in the mouth”), and ranked according to the following scales through discussions by three professional panelists. Comparative Example 11 was used as reference standard with level “1” for “dissolving feel in the mouth” and level “3” for the other evaluations. “Richness” in taste refers to strength of rich taste that the panelist feels in the presence of baked confectionery in the mouth (during eating), “plainness” refers to lightness of a taste left after the panelist swallows baked confectionery. These two tastes were ranked to respective scales. In “plainness”, the lighter after taste is ranked, the higher the level is.

### [Evaluation of Processability]

### (Lightness of Dough)

5: appropriately light and very easy to be formed

4: slightly light and easy to be formed

3: equivalent level to that of Comparative Example 11

2: slightly heavy and hard to be formed

1: very heavy and very hard to be formed

### (Integration of Dough)

5: very easy to come together and easy to be formed

4: easy to come together and easy to be formed

3: equivalent level to that of Comparative Example 11

2: little hard to come together and hard to be formed

1: a dough does not come together and is very hard to be formed

### (Firmness of Dough)

5: very firm and easy to be formed

4: firm and easy to be formed

3: equivalent level to that of Comparative Example 11

2: slightly not firm and hard to be formed

1: not firm and very hard to be formed

### [Evaluation of Taste]

### (Richness)

5: very rich

4: rich

3: equivalent level to that of Comparative Example 11

2: not rich

1: really not rich

### (Plainness)

5: very light after taste

4: light after taste

3: equivalent level to that of Comparative Example 11

2: not light after taste

1: heavy after taste

### (Dissolving Feel in the Mouth)

5: very good dissolving feel in the mouth

4: good dissolving feel in the mouth

3: slight residual matters in the mouth without problem

2: slight residual matters in the mouth

1: many residual matters in the mouth at an equivalent level to that of Comparative Example 11

From the results above, it is shown that use of the gelatinized modified starch and the liquid oils and fats within the range of the present invention allows to suppress oil-exuding in production of baked confectionery, provides a dough easy to be formed, and gives baked confectionery having improved tastes such as rich body and light after taste and improved dissolving feel in the mouth.

It is noted that Comparative Examples 3 and 6 could not be evaluated, because each dough of Comparative Examples was not firm in preparation of a dough and was impossible to be formed.

1. Baked confectionery, comprising (A) wheat flour, (B) a gelatinized modified starch, and (C) oils and fats and satisfying the conditions of (1), (2), and (3):
(1) a weight ratio of (A) to (B), (A)/(B), is 90/10 to 60/40,
(2) the content of (C) is 30 to 75 parts by weight to 100 parts by weight of (A) and (B) in total,
(3) the proportion of liquid oils and fats having a melting point not higher than 20° C. in (C) is 30 to 90% by weight.

2. The baked confectionery according to claim 1, wherein a degree of gelatinization of the gelatinized modified starch is not less than 20%.

3. The baked confectionery according to claim 1, wherein the gelatinized modified starch is a gelatinized esterified starch or a gelatinized etherified starch.

4. The baked confectionery according to claim 1, wherein the gelatinized modified starch is a gelatinized acetylated cross-linked starch or a gelatinized hydroxypropylated cross-linked starch.

5. The baked confectionery according to claim 1, wherein the liquid oils and fats contains diacylglycerol in an amount of not less than 30% by weight.

6. The baked confectionery according to claim 1, which is cookie, biscuit, shortbread or cracker.

7. Baked confectionery, comprising (A) wheat flour, (B) a gelatinized modified starch, and (C) oils and fats comprising 30% or more of diacylglycerol and satisfying the conditions of (1), (2), and (3):
(1) a weight ratio of (A) to (B), (A)/(B), is 90/10 to 60/40,
(2) the content of (C) is 30 to 75 parts by weight to 100 parts by weight of (A) and (B) in total,
(3) the proportion of liquid oils and fats (having a melting point not higher than 20° C.) comprising the diacylglycerol in an amount of not less than 30% by weight in (C) is 30 to 90% by weight.

8. The baked confectionery according to claim 7, wherein a degree of gelatinization of the gelatinized modified starch is not less than 20%.

9. The baked confectionery according to claim 7, wherein the gelatinized modified starch is a gelatinized esterified starch or a gelatinized etherified starch.

10. The baked confectionery according to claim 7, wherein the gelatinized modified starch is a gelatinized acetylated cross-linked starch or a gelatinized hydroxypropylated cross-linked starch.

11. A method for producing baked confectionery, comprising blending (A) wheat flour, (B) a gelatinized modified starch, and (C) oils and fats so as to satisfy the conditions of (1), (2) and (3) to prepare a dough, and baking the dough:
(1) a weight ratio of (A) to (B), (A)/(B), is 90/10 to 60/40,
(2) a content of (C) is 30 to 75 parts by weight to 100 parts by weight of (A) and (B) in total,
(3) a proportion of liquid oils and fats (having a melting point not higher than 20° C.) in (C) is 30 to 90% by weight.
